(19) United States
(12) Patent Application Publication
(10) Pub. No.: US 2012/0326089 A1
(43) Pub. Date: Dec. 27, 2012

(54) PHOTOLUMINESCENT NANOPARTICLES AND METHOD FOR PREPARATION

(75) Inventors: Jeffrey Anderson, Midland, MI (US); James Allen Casey, Merrill, MI (US); Vasgen Aram Shamamian, Midland, MI (US)

(73) Assignee: Dow Corning Corporation, Midland, MI (US)

(21) Appl. No.: 13/582,119

(22) PCT Filed: Feb. 28, 2011
(86) PCT No.: PCT/US2011/026491

§ 371 Date: Aug. 31, 2012

Related U.S. Application Data
(60) Provisional application No. 61/309,137, filed on Mar. 1, 2010.

(51) Int. Cl. C09K 11/59; C01B 33/021; C01B 33/027; B01J 19/08; C09K 11/02; C01B 33/02; B82Y 40/00; B82Y 30/00

(52) U.S. Cl. 252/301.36; 423/348; 423/349; 204/157.4; 977/773; 977/779; 977/896

(57) ABSTRACT

Methods for preparing photoluminescent silicon nanoparticles and compositions of such silicon nanoparticles having unique properties are provided. Methods of preparation include the use of low pressure high frequency pulsed plasma reactors and direct fluid capture of the nanoparticles formed in the reactor.

### FIELD OF THE INVENTION

The present disclosure relates generally to methods of preparing photoluminescent nanoparticles and to the resulting composition, and, more particularly, to the fluid capture of silicon nanoparticles.

### BACKGROUND

The advent of nanotechnology is resulting in a paradigm shift in many technological arts because the properties of many materials change at nanoscale dimensions. For example, decreasing the dimensions of some structures to nanoscales can increase the ratio of surface area to volume, thus causing changes in the electrical, magnetic, reactive, chemical, structural, and thermal properties of the material. Nanomaterials are already being found in commercial applications and will likely be present in a wide variety of technologies including computers, photovoltaics, optoelectronics, medicine/pharmaceuticals, structural materials, military applications, and many others within the next few decades.

Initial research efforts focused on porous silicon, but much interest and effort has now shifted from porous silicon to silicon nanoparticles. An important characteristic of small (<5 nm diameter) silicon nanoparticles is that these particles are photoluminescent in visible light when stimulated by lower wavelength sources (UV). This is thought to be caused by a quantum confinement effect that occurs when the diameter of the nanoparticle is smaller than the exciton radius, which results in bandgap bending (i.e., increasing of the gap). Researchers have shown how the bandgap energy (in electron volts) of a nanoparticle changes as a function of the diameter of the nanoparticle. See, e.g., T. Takagahara and K. Takeda, Phys. Rev. B, 46, 15578 (1992). Although silicon is an indirect bandgap semiconductor in bulk, silicon nanoparticles with diameters less than 5 nm emulate a direct bandgap material, which is made possible by interface trapping of excitons. Direct bandgap materials can be used in optoelectronics applications and so silicon nanoparticles may possibly be the dominant material in future optoelectronic applications. Another interesting property of nanomaterials is the lowering of the melting point following the surface-phonon instability theory. Researchers have shown that the melting point of a nanomaterial formed of nanoparticles changes as a function of the diameter of the nanoparticle. See, e.g., M. Wautelet, J. Phys. D: Appl. Phys., 24, 343 (1991) and A. N. Goldstein, Appl. Phys. A, 62, 33 (1996). This could lead to applications in structural materials.

Industry, universities, and laboratories have devoted substantial effort to the development of manufacturing methods and apparatuses that can be used to produce nanoparticles. Some of those techniques include microreactor plasma (R. M. Sankaran et al., Nano. Lett. 5, 537 (2005), U.S. Patent Application Publication No. 2005/0258419 by Sankaran et al., U.S. Patent Application Publication No. 2006/0042414 by Sankaran et al.), aerosol thermal decomposition of silane (K. A. Littau et. al., J Phys. Chem, 97, 1224 (1993), M. L. Ostraat et al., J. Electrochem. Soc. 148, 0265 (2001)), ultrasonication of etched silicon (G. Belomoin et al., Appl. Phys. Lett. 80, 841 (2002)), and laser ablation of silicon (J. A. Carlisle et al., Chem. Phys. Lett. 326, 335 (2000). Plasma discharge provides another opportunity to produce nanoparticles at high temperatures from atmospheric plasmas or at approximately room temperature with low pressure plasmas. High temperature plasmas have been investigated by N. P. Rao et al., U.S. Pat. Nos. 5,874,134 and 6,924,004 and U.S. Patent Application No. 2004/0046130.

Low pressure plasma has been investigated as a method to produce silicon nanoparticles since the 1990's. A group at the Tokyo Institute of Technology has produced nanocrystalline silicon particles using an ultra high vacuum (UHV) and very high frequency (VHF, ˜444 MHz) capacitively coupled plasma (S. Oda et al., J Non-Cryst. Solids, 198-200, 875 (1996); and A. Itoh et al., Mat. Res. Soc. Symp. Proc. 452, 749 (1997)). This approach uses a VHF plasma cell attached to a UHV chamber and decomposes silane with the plasma. A carrier gas of hydrogen or argon is pulsed into the plasma cell to push the nanoparticles, formed in the plasma, through an orifice into the UHV reactor where the particles are deposited. The high frequency allows efficient coupling from the rf power to the discharge producing a high ion density and ion energy plasma. Other researchers have employed an inductively coupled plasma (ICP) reactor to make a 13.56 MHz rf plasma that has high ion energy and density. (Z. Shen and U. Kortshagen, J. Vac. Sci. Technol. A, 20, 153 (2002); A. Bapat et. al. J. Appl. Phys. 94, 1969 (2003); Z. Shen et al. J. Appl. Phys. 94, 2277 (2003); and Y. Dong et al. J. Vac. Sci. Technol. B 22, 1923 (2004)).

The ICP reactor does not effectively produce nanoparticles and was replaced by a capacitively coupled discharge (A. Bapat et. al., Plasma Phys. Control Fusion 46, B97 (2004) and L. Mangolini et. al., Nano Lett. 5, 655 (2005)). The capacitively coupled system with a ring electrode was able to create a plasma instability that produces a constricted plasma that has an ion density and energy that is much higher than the surrounding glow discharge. This instability rotates around the discharge tube reducing the resident time of the particles in the high energy region. The capacitively coupled system produces smaller nanoparticles when the resident time is shorter because the resident time is approximately the time in which the conditions for nucleation of nanoparticles are favorable. Consequently, reducing the resident time reduces the amount of time available for the particles to nucleate from dissociated precursor(s) molecular fragments and affords a measure of control over the particle size distribution. This method produced nanocrystalline and luminescent silicon particles. (U.S. Patent Application No. 2006/0051505). However, the radiofrequency power in the capacitively coupled system is not sufficiently coupled to the discharge. Consequently, relatively high input power (˜200 W) is needed to deliver even modest power into the plasma (˜5 W) because much of the input radiofrequency power is reflected back to the power supply. This greatly reduces the lifetime of the power supply and reduces the cost effectiveness of this technique for production of silicon nanoparticles.

Accordingly, there remains a need in the art for methods to prepare silicon nanoparticles having diameters small enough so that the resulting particles exhibit photoluminescent properties and for capturing and storing such nanoparticles while maintaining the photoluminescent properties over time.

### SUMMARY

Embodiments of the present invention address that need and provide methods for preparing photoluminescent silicon nanoparticles having unique properties. Methods of preparation include the use of low pressure high frequency pulsed plasma reactors and direct fluid capture of the nanoparticles formed in the reactor. The silicon nanoparticles formed by these methods are directly captured in fluids for storage.

In accordance with one embodiment, a method for preparing photoluminescent nanoparticles is provided and comprises, in a plasma reactor, applying a preselected VHF radio frequency having a continuous frequency ranging from about 30 to about 500 MHz and a coupled power ranging from about 80 to about 1000 W to a reactant gas mixture to generate a plasma for a time sufficient to form silicon nanoparticles having an average diameter ranging from about 2.2 to about 4.7 nm. In some embodiments, the VHF radiofrequency is pulsed at a frequency ranging from about 1 to about 50 KHz. In some embodiments, the plasma reactor is in communication with the particle collection chamber through a pressure drop aperture or orifice.

The reactant gas mixture comprises from about 0.1 to about 50% by volume of a first precursor gas containing silicon, and at least one inert gas. The silicon nanoparticles are collected in a capture fluid such that the collection distance between the outlet of the plasma reactor and the surface of the capture fluid ranges from about 5 to about 50 aperture diameters.

In some embodiments, the reactant gas mixture is at a temperature ranging from about 20° C. to about 80° C. and a pressure ranging from about 1 to about 5 torr (about 133 Pa to about 665 Pa). In some embodiments, the capture fluid is contained in a particle collection chamber and is in communication with said plasma reactor. In some embodiments, the capture fluid is at a temperature ranging from about −20° C. to about 150° C. and a pressure ranging from about 1 to about 5 millitorr (about 0.133 Pa to about 0.665 Pa). In some embodiments, the capture fluid has a vapor pressure less than the pressure in said particle collection chamber.

In some embodiments, the first precursor gas is selected from the group consisting of silanes, disilanes, halogen-substituted silanes, halogen-substituted disilanes, C1 to C4 alkyl silanes, C1 to C4 alkyl disilanes, and mixtures thereof. In some embodiments, the reactant gas mixture further includes a second precursor gas comprising at least one element selected from the group consisting of carbon, germanium, boron, phosphorus, and nitrogen, and wherein the sum of the volumes of the first and second precursor gases comprises from about 0.1 to about 50% by volume of the reactant gas mixture. In some embodiments, the reactant gas mixture further comprises hydrogen.

In some embodiments, the capture fluid is a silicone fluid such as, for example, polydimethylsiloxane, phenylmethyl-dimethyl cyclosiloxane, tetramethyltetraphenyltrisiloxane, and pentaphenyltrimethyltrisiloxane. In some embodiments, the capture fluid is agitated. In some embodiments, the silicon nanoparticles comprise a silicon alloy selected from the group consisting of silicon carbide, silicon germanium, silicon boron, silicon phosphorus, and silicon nitride. In some embodiments, the silicon nanoparticles are doped by exposing the nanoparticles to an organosilicon compound in the capture fluid. In some embodiments, the silicon nanoparticles are passivated in the capture fluid by exposing the nanoparticles to oxygen.

Also provided is a composition comprising photoluminescent silicon nanoparticles having an average diameter ranging from about 2.2 to about 4.7 nm in a capture fluid wherein the silicon nanoparticles have a luminescent quantum efficiency that increases upon exposure to oxygen. In some embodiments, the silicon nanoparticles have a maximum emission wavelength that shifts to shorter wavelengths upon exposure to oxygen.

In some embodiments, the silicon nanoparticles have a photoluminescent intensity that increases upon exposure to oxygen. In some embodiments, the silicon nanoparticles have a photoluminescent intensity of at least 1×10⁶ at an excitation wavelength of about 365 nm. In some embodiments, the silicon nanoparticles have a quantum efficiency of at least 4% at an excitation wavelength of about 395 nm. In some embodiments, the silicon nanoparticles comprise a silicon alloy.

Accordingly, it is a feature of embodiments of the present invention to provide a method for the preparation of photoluminescent nanoparticles and the resulting product, and, more particularly, to the fluid capture of such silicon nanoparticles. This and other features and advantages of the invention will become apparent to those skilled in this art by reading the following detailed description, the accompanying drawings, and the appended claims.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1 schematically illustrates one exemplary embodiment of a low pressure pulsed plasma reactor which can be used to prepare photoluminescent nanoparticles in accordance with embodiments of the present disclosure;

FIG. 2A is a graph of the photoluminescent maximum emission wavelength of one embodiment of photoluminescent nanoparticles directly captured in a fluid as a function of time at an excitation wavelength of 365 nm; FIG. 2B is a graph of the photoluminescent maximum emission intensity of one embodiment of photoluminescent nanoparticles directly captured in a fluid as a function of time; FIG. 2C is a graph of the calculated core diameter of one embodiment of photoluminescent nanoparticles directly captured in a fluid as a function of time;

FIG. 3A is a graph of the photoluminescent maximum emission wavelength of a further embodiment of photoluminescent nanoparticles directly captured in a fluid as a function of time at an excitation wavelength of 365 nm; FIG. 3B is a graph of the photoluminescent maximum emission intensity of a further embodiment of photoluminescent nanoparticles directly captured in a fluid as a function of time; FIG. 3C is a graph of the calculated core diameter of a further embodiment of photoluminescent nanoparticles directly captured in a fluid as a function of time;

FIG. 4A is a graph of the photoluminescent maximum wavelength of a further embodiment of photoluminescent nanoparticles directly captured in a fluid as a function of time at an excitation wavelength of 365 nm; FIG. 4B is a graph of the photoluminescent maximum emission intensity of a further embodiment of photoluminescent nanoparticles directly captured in a fluid as a function of time; FIG. 4C is a graph of the calculated core diameter of a further embodiment of photoluminescent nanoparticles directly captured in a fluid as a function of time;

FIG. 5A is a graph of the photoluminescent maximum emission wavelength of a further embodiment of photoluminescent nanoparticles directly captured in a fluid as a function of time at an excitation wavelength of 365 nm; FIG. 5B is a graph of the photoluminescent maximum emission intensity of a further embodiment of photoluminescent nanoparticles directly captured in a fluid as a function of time; FIG. 5C is a graph of the calculated core diameter of a further embodiment of photoluminescent nanoparticles directly captured in a fluid as a function of time;

FIG. 6A is a graph of the photoluminescent maximum emission wavelength of a further embodiment of photoluminescent nanoparticles directly captured in a fluid as a function of time at an excitation wavelength of 365 nm; FIG. 6B is a graph of the photoluminescent maximum emission intensity of a further embodiment of photoluminescent nanoparticles directly captured in a fluid as a function of time; FIG. 6C is a graph of the calculated core diameter of a further embodiment of photoluminescent nanoparticles directly captured in a fluid as a function of time;

FIG. 7A is a graph of the photoluminescent maximum emission wavelength of a further embodiment of photoluminescent nanoparticles directly captured in a fluid as a function of time at an excitation wavelength of 365 nm; FIG. 7B is a graph of the photoluminescent maximum emission intensity of a further embodiment of photoluminescent nanoparticles directly captured in a fluid as a function of time; FIG. 7C is a graph of the calculated core diameter of a further embodiment of photoluminescent nanoparticles directly captured in a fluid as a function of time;

FIG. 8 is a graph illustrating an initial and day 35 emission spectrum of one embodiment of photoluminescent nanoparticles directly captured in a fluid as measured with a spectrofluorometer at an excitation wavelength of 365 nm;

FIG. 9 is a Bright field transmission electron microscope photomicrograph of the luminescent quantum efficiency of another embodiment of photoluminescent nanoparticles directly captured in a fluid as measured with an Fiber Optic Spectrometer with a 395 nm LED source;

FIG. 10 is a graph of the initial and day 35 emission spectra of silicon nanoparticles as measured at an excitation wavelength of 365 nm;

FIG. 11 is a graph of a normalized photoluminescent emission spectra of three embodiments of photoluminescent nanoparticles emitting in the green, orange, and red portions, respectively, which were directly captured in a fluid; and

FIG. 12 shows the photoluminescent emission spectrum of one embodiment of photoluminescent Si nanoparticles directly captured in polydimethylsiloxane (PDMS) as a function of particle size initially after deposition and after 40 days of ambient air exposure.

### DETAILED DESCRIPTION

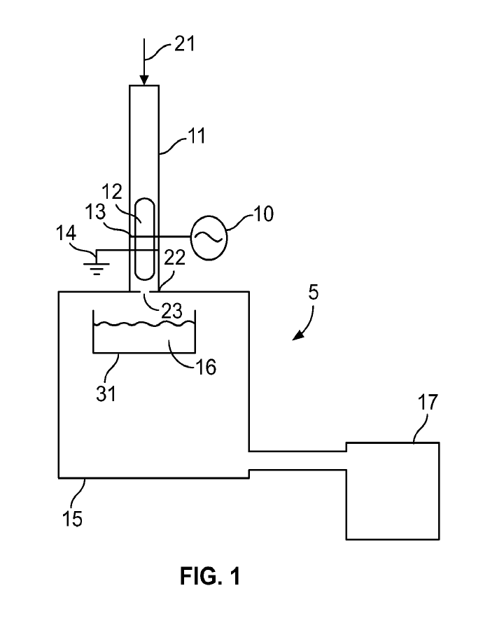

Referring initially to FIG. 1, photoluminescent silicon nanoparticles are prepared by providing at least a first reactant gas mixture to a plasma reactor system 5. In one embodiment, the reactant gas mixture comprises a first reactive precursor gas and an inert gas. Preferably, the first reactive precursor gas comprises from about 0.1% to about 50% of the total volume of the reactant gas mixture. However, it is also contemplated that the first reactive precursor gas may comprise other volume percentages such as from about 1% to about 50% of the total volume of the reactant gas mixture.

Preferably, the first reactive precursor gas contains silicon. Generally, the first reactive precursor gas is selected from silanes, disilanes, halogen-substituted silanes, halogen-substituted disilanes, C1-C4 alkyl silanes, C1 to C4 alkyldisilanes, and mixtures thereof. In one embodiment, the reactant gas mixture may comprise silane which comprises from about 0.1 to about 2% of the total reactant gas mixture. However, the reactant gas mixture may also comprise other percentages of silane. Alternatively, the first reactive precursor gas may also comprise, but is not limited to, SiCl₄, HSiCl₃, and H₂SiCl₂.

The reactant gas mixture may also optionally comprise an inert gas. Preferably, the inert gas comprises argon. Alternatively, it is also contemplated that the inert gas may comprise xenon, neon, or a mixture of inert gases. When present in the reactant gas mixture, the inert gas may comprise from about 1% to about 99% of the total volume of the reactant gas mixture. However, other volume percentages of inert gas are also contemplated.

In one embodiment, the reactant gas mixture also comprises a second precursor gas which itself can comprise from about 0.1 to about 49.9 volume % of the reactant gas mixture. The second precursor gas comprises BCl₃, B₂H₆, PH₃, GeH₄, or GeCl₄. Alternatively, the second precursor gas may comprise other gases that contain carbon, germanium, boron, phosphorus, or nitrogen. Preferably, the combination of the first reactive precursor gas and the second precursor gas together make up from about 0.1 to about 50% of the total volume of the reactant gas mixture.

In another embodiment, the reactant gas mixture further comprises hydrogen gas. Preferably, hydrogen gas is present in an amount of from about 1% to about 10% of the total volume of the reactant gas mixture. However, it is also contemplated that the reactant gas mixture may comprise other percentages of hydrogen gas.

Referring again to FIG. 1, in one embodiment, the plasma reactor system 5 comprises a plasma generating chamber 11 having a reactant gas inlet 21 and an outlet 22 having an aperture or orifice 23 therein. A particle collection chamber 15 is in communication with the plasma generating chamber 11. The particle collection chamber 15 contains a capture fluid 16 in a container 31. Container 31 may be adapted to be agitated (by means not shown). For example, container 31 may be positioned on a rotatable support (not shown) or may include a stirring mechanism. Preferably the capture fluid is a liquid at the temperatures of operation of the system. The capture fluid preferably comprises a silicone fluid such as, for example, polydimethylsiloxane, phenylmethyl-dimethyl cyclosiloxane, tetramethyltetraphenyltrisiloxane, and pentaphenyltrimethyltrisiloxane. The plasma reactor system 5 also includes a vacuum source 17 in communication with the particle collection chamber 15 and plasma generating chamber 11.

The plasma generating chamber 11 comprises an electrode configuration 13 that is attached to a variable frequency rf amplifier 10. The plasma generating chamber 11 also comprises a second electrode configuration 14. The second electrode configuration 14 is either ground, DC biased, or operated in a push-pull manner relative to the electrode 13. The electrodes 13, 14 are used to couple the very high frequency (VHF) power to the reactant gas mixture to ignite and sustain a glow discharge of plasma within the area identified as 12. The first reactive precursor gas (or gases) is then dissociated in the plasma to provide charge silicon atoms which nucleate to form silicon nanoparticles having an average silicon core diameter of less than about 5 nm, and preferably from between about 2.2 to about 4.7 nm. However, other discharge tube configurations are contemplated, and may be used in carrying out the method disclosed herein.

The silicon nanoparticles are collected in particle collection chamber 15 in the capture fluid. To control the diameter of the nanoparticles which are formed, the distance between the aperture 23 in the outlet 22 of plasma generating chamber 11 and the surface of the capture fluid ranges between about 5 to about 50 aperture diameters. We have found that positioning the surface of the capture fluid too close to the outlet of the plasma generating chamber may result in undesirable interactions of plasma with the capture fluid. Conversely, positioning the surface of the capture fluid too far from the aperture reduces particle collection efficiency. As collection distance is a function of the aperture diameter of the outlet and the pressure drop between the plasma generating chamber and the collection chamber, we have found that based on the operating condition described herein, an acceptable collection distance id from about 1 to about 20 cm, and preferably from about 5 to about 10 cm. Stated another way, an acceptable collection distance is from about 5 to about 50 aperture diameters.

The plasma generating chamber 11 also comprises a power supply. The power is supplied via a variable frequency radio frequency power amplifier 10 that is triggered by an arbitrary function generator to establish high frequency pulsed plasma in area 12. Preferably, the radiofrequency power is capacitively coupled into the plasma using a ring electrode, parallel plates, or an anode/cathode setup in the gas. Alternatively, the radiofrequency power may be inductively coupled mode into the plasma using an rf coil setup around the discharge tube.

In one embodiment, the plasma generating chamber 11 may also comprise a dielectric discharge tube. Preferably, a reactant gas mixture enters the dielectric discharge tube where the plasma is generated. Nanoparticles which form from the reactant gas mixture start to nucleate as the first reactive precursor gas molecules are dissociated in the plasma.

In one embodiment, the vacuum source 17 comprises a vacuum pump. The vacuum source 17 may comprise a mechanical, turbo molecular, or cryogenic pump. However, other vacuum sources are also contemplated.

In one embodiment, the electrodes 13, 14 for a plasma source inside the plasma generating chamber 11 comprise a flow-through showerhead design in which a VHF radio frequency biased upstream porous electrode plate 13 is separated from a down stream porous electrode plate 14, with the pores of the plates aligned with one another. The pores may be circular, rectangular, or any other desirable shape. Alternatively, the plasma generating chamber 11 may enclose an electrode 13 that is coupled to the VHF radio frequency power source and has a pointed tip that has a variable distance between the tip and a grounded ring inside the chamber 11.

In one embodiment, the VHF radio frequency power source operates in a frequency range of about 30 to about 500 MHz. In another alternative embodiment, the pointed tip 13 can be positioned at a variable distance from a VHF radio frequency powered ring 14 operated in a push-pull mode (180° out of phase). In yet another alternative embodiment, the electrodes 13, 14 include an inductive coil coupled to the VHF radio frequency power source so that radio frequency power is delivered to the reactant gas mixture by an electric field formed by the inductive coil. Portions of the plasma generating chamber 11 can be evacuated to a vacuum level ranging between about 1×10⁻⁷ to about 500 Torr. However, other electrode coupling configurations are also contemplated for use with the method disclosed herein.

In the illustrated embodiment, the plasma in area 12 is initiated with a high frequency plasma via an rf power amplifier such as, for example, an AR Worldwide Model KAA2O4O, or an Electronics and Innovation Model 3200L, or an EM Power RF Systems, Inc. Model BBS2E3KUT. The amplifier can be driven (or pulsed) by an arbitrary function generator (e.g., a Tektronix AFG3252 function generator) that is capable of producing up to 200 watts of power from 0.15 to 150 MHz. In several embodiments, the arbitrary function may be able to drive the power amplifier with pulse trains, amplitude modulation, frequency modulation, or different waveforms. The power coupling between the amplifier and the reactant gas mixture typically increases as the frequency of the rf power increases. The ability to drive the power at a higher frequency may allow more efficient coupling between the power supply and discharge. The increased coupling may be manifested as a decrease in the voltage standing wave ratio (VSWR).

$$VSWR = \frac{1 + p}{1 - p} , \qquad ( 1 )$$

where p is the reflection coefficient,

$$p = \frac{Zp - Zc}{Zc + Zp} \qquad ( 2 )$$

with Zp and Zc representing the impedance of the plasma and coil respectively. At frequencies below 30 MHz, only 2-15% of the power is delivered to the discharge. This has the effect of producing high reflected power in the rf circuit that leads to increased heating and limited lifetime of the power supply. In contrast, higher frequencies allow more power to be delivered to the discharge, thereby reducing the amount of reflected power in the rf circuit.

In one embodiment, the power and frequency of the plasma system is preselected to create an optimal operating space for the formation of photoluminescent silicon nanoparticles. Preferably, tuning both the power and frequency creates an appropriate ion and electron energy distribution in the discharge to help dissociate the molecules of silicon-containing reactive precursor gas and nucleate the nanoparticles. Appropriate control of both the power and frequency prevents the silicon nanoparticles from growing too large.

Referring again to FIG. 1, one exemplary embodiment of a low pressure high frequency pulsed plasma reactor 5 is schematically illustrated. In the illustrated embodiment, a reactant gas mixture is introduced to a plasma generating chamber 11. The plasma reactor 5 may be operated in the frequency range of from 30 MHz to 150 MHz, at pressures from about 100 mTorr to about 10 Torr in the plasma generating chamber 11, and with a power of from about 1 W to about 200 W. However, other powers, pressures, and frequencies of the plasma reactor 5 are also contemplated.

The pulsed plasma system illustrated in FIG. 1 may be used to produce photoluminescent silicon nanoparticles. Pulsing the plasma enables an operator to directly manage the resident time for particle nucleation, and thereby control the particle size distribution and agglomeration kinetics in the plasma. The pulsing function of the system allows for controlled tuning of the particle resident time in the plasma, which affects the size of the nanoparticles. By decreasing the “on” time of the plasma, the nucleating particles have less time to agglomerate, and therefore the size of the nanoparticles may be reduced on average (i.e., the nanoparticle distribution may be shifted to smaller diameter particle sizes).

Advantageously, the operation of the plasma reactor system 5 at higher frequency ranges, and pulsing the plasma provides the same conditions as in conventional constricted/filament discharge techniques that use a plasma instability to produce the high ion energies/densities, but with the additional advantage that users can control operating conditions to select and produce nanoparticles having sizes which result in photoluminescent properties.

For a pulse injection, the synthesis of the nanoparticles can be done with a pulsed energy source, such as a pulsed very high frequency rf plasma, a high frequency rf plasma, or a pulsed laser for pyrolysis. Preferably, the VHF radiofrequency is pulsed at a frequency ranging from about 1 to about 50 kHz. However, it is also contemplated that the VHF radiofrequency may be pulsed at other frequencies.

Another method to transfer the nanoparticles to the capture fluid is to pulse the input of the reactant gas mixture while the plasma is ignited. For example, one could ignite the plasma in which a first reactive precursor gas is present is ignited to synthesize the Si nanoparticles, with at least one other gas present to sustain the discharge, such as an inert gas. The nanoparticle synthesis is stopped when the flow of first reactive precursor gas is stopped with a mass flow controller. The synthesis of the nanoparticles continues when the flow of the first reactive precursor gas is started again. This produces a pulsed stream of nanoparticles. This technique can be used to increase the concentration of nanoparticles in the capture fluid if the flux of nanoparticles impinging on the capture fluid is greater than the absorption rate of the nanoparticles into the capture fluid.

Generally, the nanoparticles can be synthesized at increased plasma residence time relative to the precursor gas molecular residence time through a VHF radio frequency low pressure plasma discharge. Alternatively, crystalline nanoparticles can be synthesized at lower plasma residence times at the same operating conditions of discharge drive frequency, drive amplitude, discharge tube pressure, chamber pressure, plasma power density, gas molecule residence time through the plasma, and collection distance from plasma source electrodes. In one embodiment, the mean particle diameter of nanoparticles can be controlled by controlling the plasma residence time and a high ion energy/density region of a VHF radio frequency low pressure glow discharge can be controlled relative to at least one precursor gas molecular residence time through the discharge.

The size distribution of the nanoparticles can also be controlled by controlling the plasma residence time, a high ion energy/density region of the VHF radio frequency low pressure glow discharge relative to said at least one precursor gas molecular residence time through the discharge. Typically, the lower the plasma residence time of a VHF radio frequency low pressure glow discharge relative to the gas molecular residence time, the smaller the mean nanoparticle diameter at constant operating conditions. The operating conditions may be defined by the discharge drive frequency, drive amplitude, discharge tube pressure, chamber pressure, plasma power density, precursor mass flow rates, and collection distance from plasma source electrodes. However, other operating conditions are also contemplated. For example, as the plasma residence time of a VHF radio frequency low pressure glow discharge relative to the gas molecular residence time increases, the mean nanoparticle diameter follows an exponential growth model of y=y₀−exp(−tᵣ/C), where y is the mean nanoparticle diameter, y₀ is the offset, tᵣ is the plasma residence time, and C is a constant. The particle size distribution may also increase as the plasma residence time increases under otherwise constant operating conditions.

In another embodiment, the mean particle diameter of the nucleated nanoparticles (as well as the nanoparticle size distribution) can be controlled by controlling a mass flow rate of at least one precursor gas in a VHF radio frequency low pressure glow discharge. For example, as the mass flow rate of precursor gas (or gases) increases in the VHF radio frequency low pressure plasma discharge, the synthesized mean nanoparticle diameter may decrease following an exponential decay model of the form y=yₒ+exp(−MFR/C′), where y is the mean nanoparticle diameter, yₒ is the offset, MFR is the precursor mass flow rate, and C′ is a constant, for constant operating conditions. Typical operating conditions may include discharge drive frequency, drive amplitude, discharge tube pressure, chamber pressure, plasma power density, gas molecule residence time through the plasma, and collection distance from plasma source electrodes. The synthesized mean core nanoparticle particle size distribution may also decrease as an exponential decay model of the form y=yₒ+exp(−MFR/K), where y is the mean nanoparticle diameter, yₒ is the offset, MFR is the precursor mass flow rate, and K is a constant, for constant operating conditions.

As described previously, the nucleated nanoparticles formed in the plasma generating chamber 11 are transferred to a particle collection chamber 15 containing the capture fluid 16. Preferably, the charged nanoparticles may be evacuated from chamber 11 to the particle collection chamber 15 by cycling the plasma to a low ion energy state, or by turning the plasma off. Upon transfer to the particle collection chamber 15, the nucleated nanoparticles are absorbed into the capture fluid.

In another embodiment, the nucleated nanoparticles are transferred from the plasma generating chamber 11 to particle collection chamber 15 containing capture fluid via an aperture or orifice 23 which creates a pressure differential. It is contemplated that the pressure differential between the plasma generating chamber 11 and the particle collection chamber 15 can be controlled through a variety of means. In one configuration, the discharge tube inside diameter of the plasma generating chamber 11 is much less than the inside diameter of the particle collection chamber 15, thus creating a pressure drop. In another configuration, a grounded physical aperture or orifice may be placed between the discharge tube and the collection chamber 15 that forces the plasma to reside partially inside the orifice, based on the Debye length of the plasma and the size of the chamber 15. Another configuration comprises using a varying electrostatic orifice in which a positive concentric charge is developed that forces the negatively charged plasma through the aperture 23.

It is contemplated that the capture fluid may be used as a material handling and storage medium. In one embodiment, the capture fluid is selected to allow nanoparticles to be absorbed and disperse into the fluid as they are collected, thus forming a dispersion or suspension of nanoparticles in the capture fluid. Nanoparticles will be adsorbed into the fluid if they are miscible with the fluid.

The capture fluid is selected to have the desired properties for silicon nanoparticle capture and storage. In a specific embodiment, the vapor pressure of the capture fluid is lower than the operating pressure in the plasma reactor. Preferably, the operating pressure in the reactor and collection chamber 15 range from about 1 to about 5 millitorr. Other operating pressures are also contemplated. Fluids that may be used as the capture fluid include, but are not limited to, silicone fluids. For example, silicone fluids such as polydimethylsiloxane, mixed phenylmethyl-dimethyl cyclosiloxane, tetramethyltetraphenyltrisiloxane, and penta phenyltrimethyltrisiloxane are all suitable for use as capture fluids.

In one embodiment, the capture liquid is agitated during the direct capture of the nanoparticles. Contemplated forms of agitation that are acceptable include stirring, rotation, inversion, and other suitable means. If higher absorption rates of the nanoparticles into the capture liquid are desired, more intense forms of agitation are contemplated. For example, one method of such intense agitation contemplated for use includes ultrasonication.

Upon the dissociation of the first reactive precursor gas in the plasma generation chamber 11, silicon nanoparticles form and are entrained in the gas phase. The distance between the nanoparticle synthesis location and the surface of capture fluid must be short enough so that no unwanted functionalization occurs while the nanoparticles are entrained. If particles interact within the gas phase, agglomerations of numerous individual small particles will form and be captured in the capture fluid. If too much interaction takes place within the gas phase, the particles may sinter together and form particles larger than 5nm in diameter. The collection distance is defined as the distance from the outlet of the plasma generating chamber to the surface of the capture fluid. In one embodiment, the collection distance ranges from about 5 to about 50 aperture diameters.

Stated another way, the collection distance ranges from about 1 to about 20 cm. The collection distance may more usually range from between about 6 to about 12 cm, and preferably from about 5 to about 10 cm. However, other collection distances are also contemplated.

In one embodiment, the nanoparticles may comprise silicon alloys. Silicon alloys that may be formed include, but are not limited to, silicon carbide, silicon germanium, silicon boron, silicon phosphorus, and silicon nitride. The silicon alloys may be formed by mixing at least one first precursor gas with the second precursor gas or using a precursor gas that contains the different elements. However, other methods of forming alloyed nanoparticles are also contemplated.

In another embodiment, the silicon nanoparticles may undergo an additional doping step. Preferably, the silicon nanoparticles undergo gas phase doping in the plasma, where a second precursor gas is dissociated and is incorporated in the silicon nanoparticles as they are nucleated. Alternatively, the silicon nanoparticles may undergo doping in the gas phase downstream of the production of the nanoparticles, but before the silicon nanoparticles are captured in the liquid. Furthermore, doped silicon nanoparticles may also be produced in the capture fluid where the dopant is preloaded into the capture fluid and interacts with the nanoparticles after they are captured. Doped nanoparticles can be formed by contact with organosilicon gases or liquids, including, but not limited to trimethylsilane, disilane, and trisilane. Gas phase dopants may include, but are not limited to, BCl₃, B₂H₆, PH₃, GeH₄, or GeCl₄.

The direct liquid capture of the nanoparticles in fluid provides unique properties of the composition. Silicon nanoparticles that are directly captured in a capture fluid show visible photoluminescence when removed from the system and excited by exposure to UV light. Depending on the average diameter of the nanoparticles, they may photoluminesce in any of the wavelengths in the visible spectrum and may visually appear to be red, orange, green, blue, violet, or any other color in the visible spectrum. In one embodiment, the photoluminescent silicon nanoparticles which are directly captured have a photoluminescent intensity of at least 1×10⁶ at an excitation wavelength of about 365 nm. In another embodiment, the photoluminescent silicon nanoparticles which are directly captured have a quantum efficiency of at least 4% at an excitation wavelength of about 395 nm as measured on a Ocean Optics spectrophotometer with an integrating sphere with an absorption of >10% of the incident photons.

Furthermore, both the photoluminescent intensity and luminescent quantum efficiency of the direct capture composition continue to increase over time when the nanoparticle containing capture fluid is exposed to air. In another embodiment, the maximum emission wavelength of the nanoparticles directly captured in a fluid shift to shorter wavelengths over time when exposed to oxygen. Preferably, the luminescent quantum efficiency of the directly captured silicon nanoparticle composition is increased by about 200% to about 2500% upon exposure to oxygen. However, other increases in the luminescent quantum efficiency are also contemplated. The photoluminescent intensity may increase from 400 to 4500% depending on the time exposure to oxygen and the concentration of the silicon nanoparticles in the fluid. However, other increases in the photoluminescent intensity are also contemplated. The wavelength emitted from the direct capture composition also experiences a blue shift of the emission spectrum. In one embodiment, the maximum emission wavelength shifts about 100 nm, based on about a 1 nm decrease in silicon core size, depending on the time exposed to oxygen. However, other maximum emission wavelength shifts are also contemplated.

In one embodiment, because the direct capture composition experiences increases in luminescent quantum efficiency and photoluminescent intensity upon exposure to oxygen, there is no need for a moisture barrier in a capping layer that may be used for the particles.

In another embodiment, the capture liquid containing silicon nanoparticles is passivated by exposing the liquid to an oxygen containing environment. In another embodiment, the capture liquid containing silicon nanoparticles may be passivated with other means. One such alternative means of passivation is forming a nitride surface layer on the silicon core nanoparticles, by bubbling a nitrogen-containing gas such as ammonia gas into the capture fluid.

### EXAMPLE 1

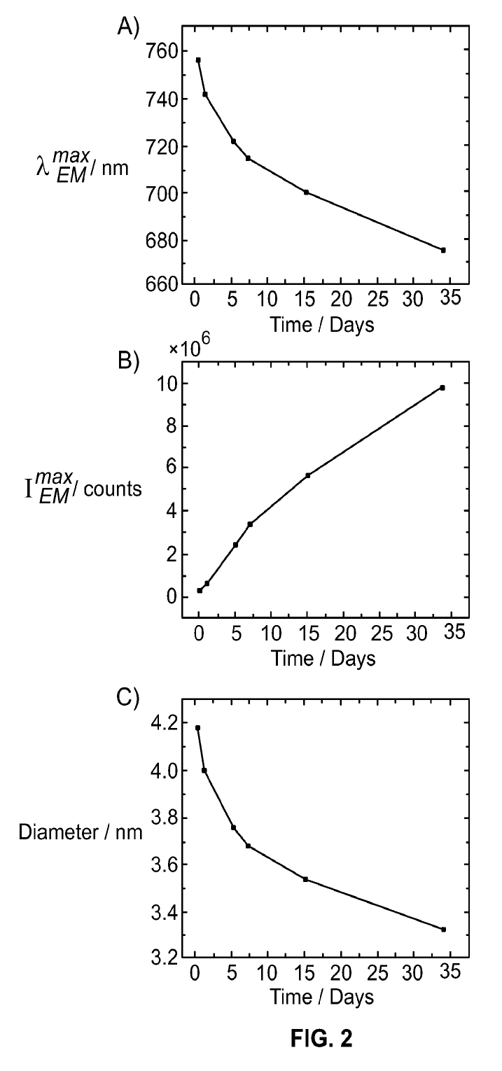

The graphs of FIGS. 2A-2C show the results of a deposition of 0.06 wt % silicon nanoparticles captured in 100 cSt PDMS. The silicon nanoparticles were formed using 0.31 vol. % SiH₄ and 5.3 vol. % of H₂ balanced with Ar plasma operating at 127 MHz and 125 W at 3.7 Torr for 30 minutes with the capture fluid placed 9 cm downstream of the plasma at a pressure of 3.5 mTorr. FIG. 2A shows the photoluminescent emission maximum wavelength of the material (measured on a Horiba FluoroLog 3 spectrofluorometer at an excitation of 365 nm) as a function of time. FIG. 2B shows the photoluminescent emission intensity maximum of the sample as a function of time. FIG. 2C shows the calculated Si core diameter as a function of time. The sample was left exposed to ambient air throughout the time period. The emission maximum blue shifted 80.5 nm, while the emission intensity increased 39.1 times with the exposure to air. The calculated Si core diameter decreased 0.85 nm over this time period due to surface oxidation of the crystalline nanoparticles.

### EXAMPLE 2

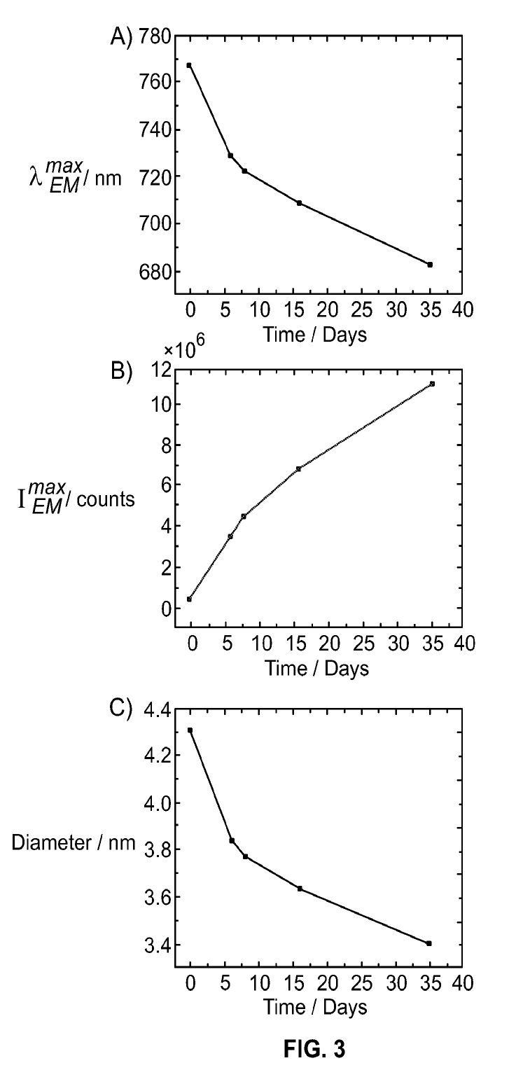

The graphs in FIGS. 3A-3C show the deposition of 0.021 wt. % of Si nanoparticles captured in 100 cSt PDMS. The silicon nanoparticles were formed using 0.31 vol. % SiH₄ and 5.3 vol. % of H₂ balanced with Ar plasma operating at 127 MHz and 125 W at 3.7 Torr for 20 minutes. The capture fluid was placed 9 cm downstream of the plasma at a pressure of 3.5 mTorr. FIG. 3A shows the photoluminescent emission maximum wavelength of the material (measured on a Horiba FluoroLog 3 spectrofluorometer at an excitation of 365 nm) as a function of time. FIG. 3B shows the photoluminescent emission intensity maximum of the sample as a function of time. FIG. 3C shows the calculated Si core diameter as a function of time. The sample was left exposed to ambient air throughout the time period. The emission maximum blue shifted 85 nm, while the emission intensity increased 27.4 times with the exposure to air. The calculated Si core decreased 0.92 nm over this time period due to surface oxidation of the crystalline nanoparticles.

### EXAMPLE 3

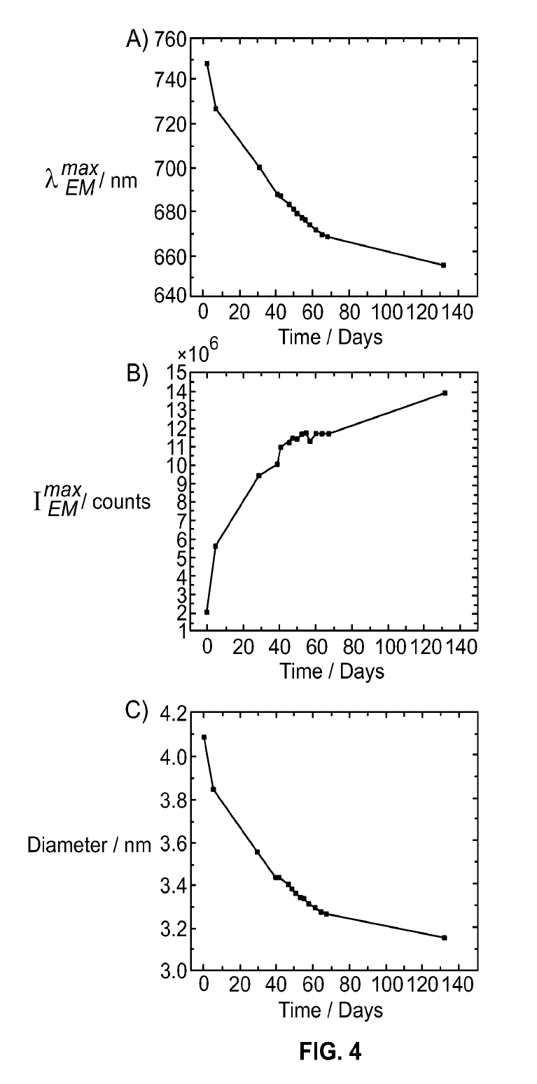

The graphs of FIGS. 4A-4C show the deposition of 0.0127 wt. % of Si nanoparticles captured in 100 cSt PDMS. The silicon nanoparticles were formed using 0.24 vol. % SiH₄ and 8 vol. % of H₂ balanced with Ar plasma operating at 127 MHz and 112 W at 4.25 Torr for 30 minutes. The capture fluid was placed 9 cm downstream of the plasma at a pressure of 5.2 mTorr. FIG. 4A shows the photoluminescent emission maximum wavelength of the material (measured on a Horiba FluoroLog 3 spectrofluorometer at an excitation of 365 nm) as a function of time. FIG. 4B shows the photoluminescent emission intensity maximum of the sample as a function of time. FIG. 4C shows the calculated Si core diameter as a function of time. The sample was left exposed to ambient air throughout the time period. The emission maximum blue shifted 95 nm, while the emission intensity increased 6.8 times with the exposure to air. The calculated Si core decreased 0.93 nm over this time period due to surface oxidation of the crystalline nanoparticles.

### EXAMPLE 4

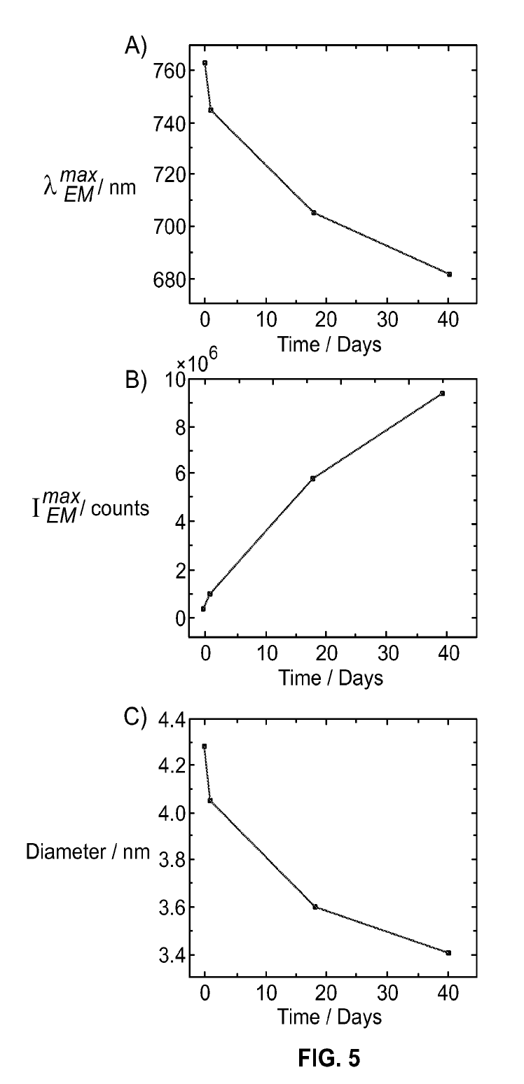

The graphs of FIGS. 5A-5C show the deposition of 0.03 wt. % of Si nanoparticles captured in 100 cSt PDMS. The silicon nanoparticles were formed using 0.31 vol. % SiH₄ and 5.3 vol. % of H₂ balanced with Ar plasma operating at 127 MHz and 125 W at 3.68 Torr for 15 minutes. The capture fluid placed 9 cm downstream of the plasma at a pressure of 3.5 mTorr. FIG. 5A shows the photoluminescent emission maximum wavelength of the material (measured on a Horiba FluoroLog 3 spectrofluorometer at an excitation of 365 nm) as a function of time. FIG. 5B shows the photoluminescent emission intensity maximum of the sample as a function of time. FIG. 5C shows the calculated Si core diameter as a function of time. The sample was left exposed to ambient air throughout the time period. The emission maximum blue shifted 78 nm, while the emission intensity increased 17.3 times with the exposure to air. The calculated Si core decreased 0.86 nm over this time period due to surface oxidation of the crystalline nanoparticles.

### EXAMPLE 5

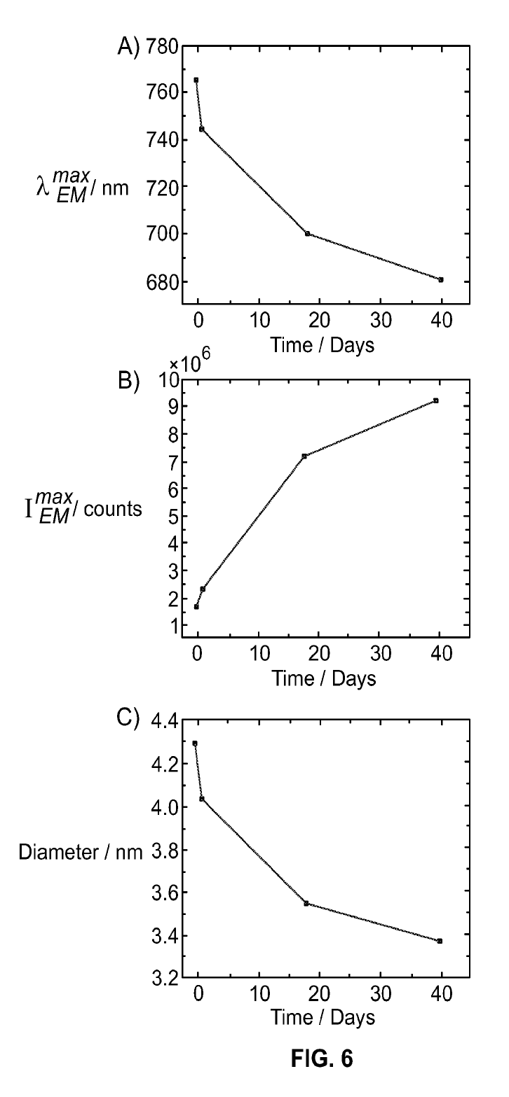

The graphs of FIGS. 6A-6C show the deposition of 0.01 wt. % of Si nanoparticles captured in 100 cSt PDMS. The silicon nanoparticles were formed using 0.31 vol. % SiH₄ and 5.3 vol. % of H₂ balanced with Ar plasma operating at 127 MHz and 126 W at 3.69 Torr for 5 minutes. The capture fluid was placed 9 cm downstream of the plasma at a pressure of 3.5 mTorr. FIG. 6A shows the photoluminescent emission maximum wavelength of the material (measured on a Horiba FluoroLog 3 spectrofluorometer at an excitation of 365 nm) as a function of time. FIG. 6B shows the photoluminescent emission intensity maximum of the sample as a function of time. FIG. 6C shows the calculated Si core diameter as a function of time. The sample was left exposed to ambient air throughout the time period. The emission maximum blue shifted 86 nm, while the emission intensity increased 5.7 times with the exposure to air. The calculated Si core decreased 0.93 nm over this time period due to surface oxidation of the crystalline nanoparticles.

### EXAMPLE 6

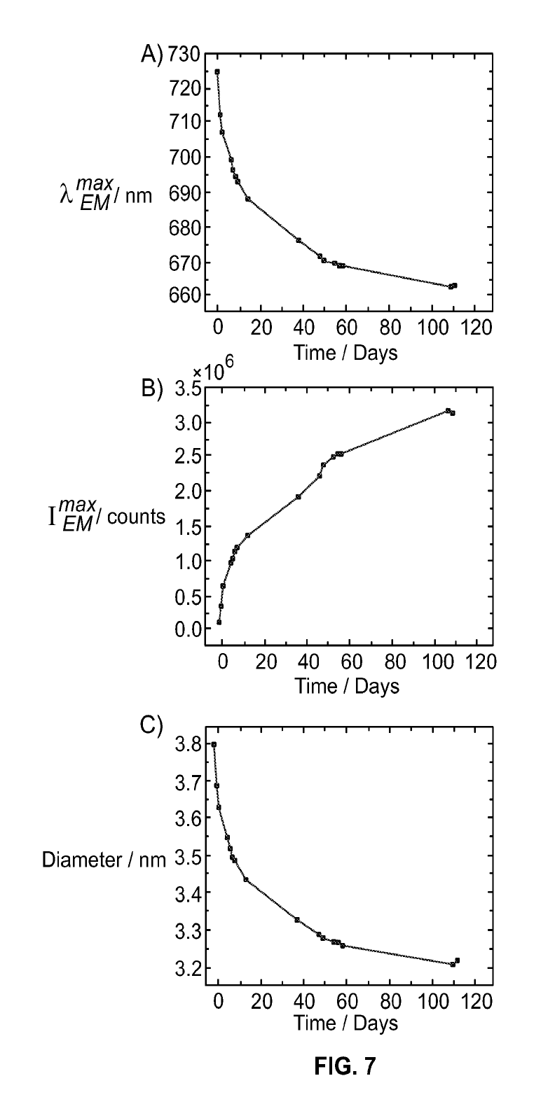

The graphs of FIGS. 7A-7C show the deposition of 0.003 wt. % of Si nanoparticles captured in 100 cSt PDMS. The silicon nanoparticles were formed using 0.33 vol. % SiH₄ and 1.6 vol. % of H₂ balanced with Ar plasma operating at 127 MHz and 124 W at 3.91 Torr for 10 minutes. The capture fluid was placed 9 cm downstream of the plasma at a pressure of 3.2 mTorr. FIG. 7A shows the photoluminescent emission maximum wavelength of the material (measured on a Horiba FluoroLog 3 spectrofluorometer at an excitation of 365 nm) as a function of time. FIG. 7B shows the photoluminescent emission intensity maximum of the sample as a function of time. FIG. 7C shows the calculated Si core diameter as a function of time. The sample was left exposed to ambient air throughout the time period. The emission maximum blue shifted 62 nm, while the emission intensity increased 33 times with the exposure to air. The calculated Si core decreased 0.58 nm over this time period due to surface oxidation of the crystalline nanoparticles.

### EXAMPLE 7

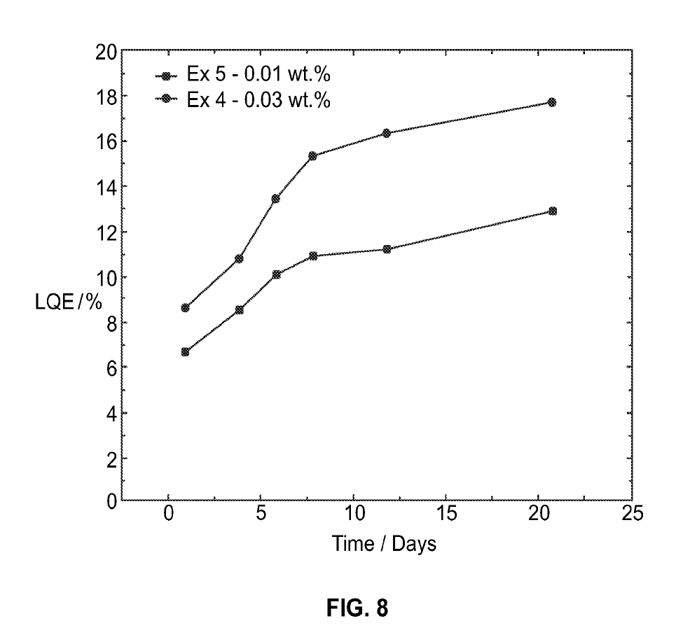

FIG. 8 shows the luminescent quantum efficiency (LQE) of the results of the silicon nanoparticles described in Examples 4 and 5, respectively, as a function of time. The nanoparticles in the capture fluid were exposed to ambient air as measure via an Ocean Optics USB4000 Fiber Optic Spectrometer with a 395 nm LED source. The LQE continues to increase as the sample is exposed to air.

### EXAMPLE 8

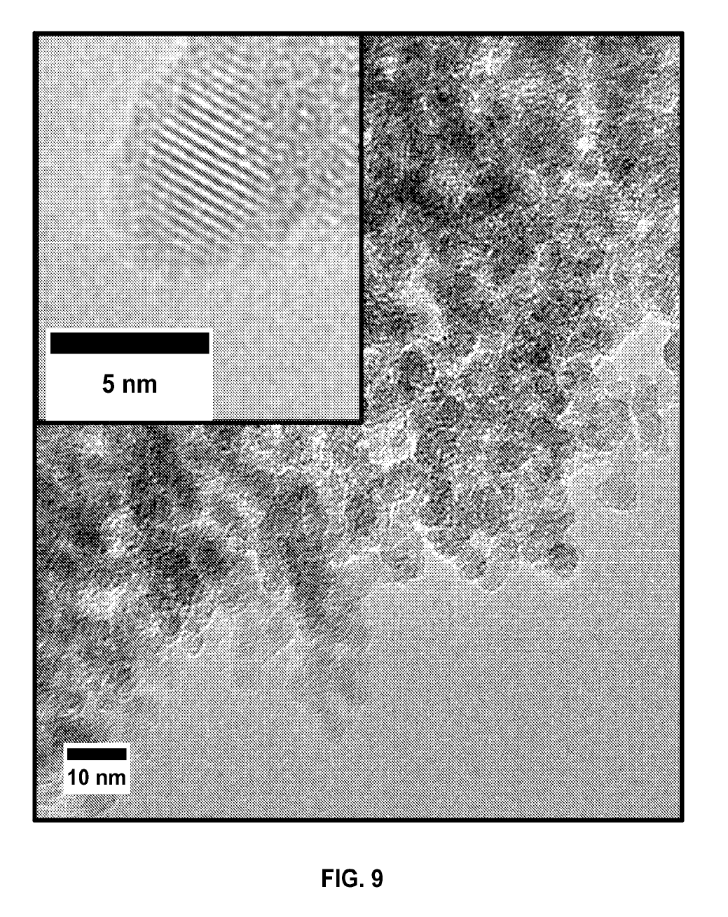

Using the same conditions as reported in Example 4, FIG. 9 shows a Bright field transmission electron microscope micrograph of Si nanoparticles deposited on a ultra-fine lacy carbon coated copper TEM grid placed 9 cm downstream of the plasma at a pressure of 3.5 mTorr. The plasma consisted of 0.31 vol. % SiH₄ and 5.3 vol. % of H₂ balanced with Ar plasma operating at 127 MHz and 125 W at 3.7 Torr. This demonstrates that crystalline silicon nanoparticles are formed by the process.

### EXAMPLE 9

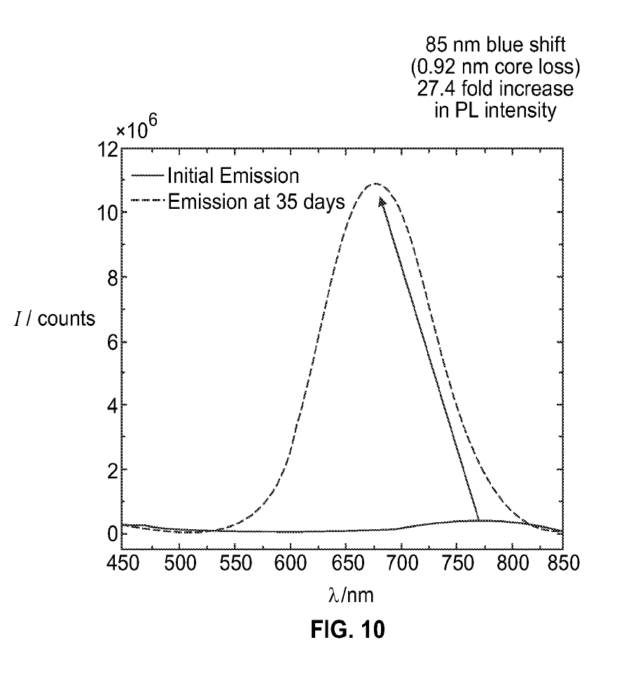

FIG. 10 shows the initial and day 35 emission spectrum of the particles captured in Example 2 as measured with a Horiba FluoroLog 3 spectrofluorometer at an excitation wavelength of 365 nm. The 85 nm blue shift is visible, correlated to a decrease in silicon core diameter of 0.92 nm, along with the 27.4 fold increase in the emission intensity.

### EXAMPLE 10

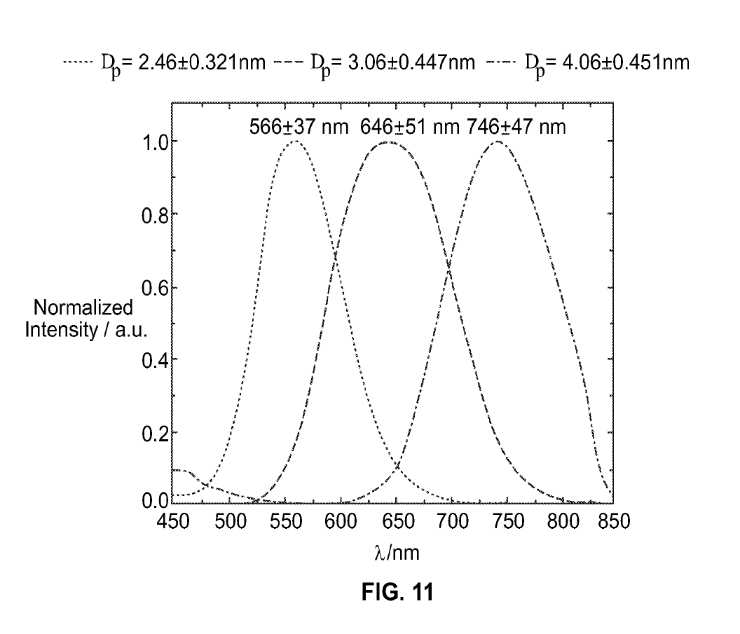

FIG. 11 shows the normalized photoluminescent emission spectra, with the standard deviation of the emission curves labeled, (excitation at 365 nm) of three samples of Si nanoparticles captured into 100 cSt PDMS with conditions similar to those reported in Example 3. The differences in the sample emission spectra are the exposure time to air. The emission peaks at 746, 646, and 566 nm are from samples measured at 1, 145, and 250 days exposure to air, respectively. The calculated particle size and standard deviations for each spectrum are labeled.

### EXAMPLE 11

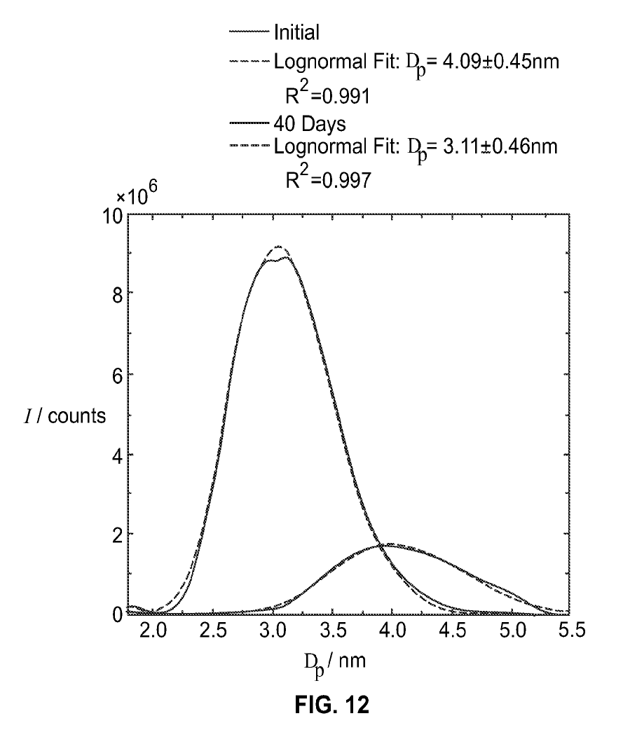

FIG. 12 shows the photoluminescent emission spectrum of a Si nanoparticle directly captured in 100 cSt PDMS as a function of particle size initially after deposition and 40 days of ambient air exposure. The log normal fit and fit parameters are given to show the expected log normal distribution associated with a gas phase process. The diameter of the Si nanoparticle can be calculated from the following equation:

$${D}_{p} = \frac{2.57811}{{( h \cdot c / λ - {E}_{g} )}^{1 / 1.39}}$$

As set forth in Proot, et. al. Appl. Phys. Lett., 61, 1948 (1992); Delerue, et. al. Phys. Rev. B., 48, 11024 (1993); and Ledoux, et. al. Phys. Rev. B., 62, 15942 (2000), where h is Plank's constant, c is the speed of light, and E_{g} is the bulk band gap of Si.

Recitations herein of “at least one” component, element, etc., should not be used to create an inference that the alternative use of the articles “a” or “an” should be limited to a single component, element, etc.

Terms like “preferably,” “commonly,” and “typically,” when utilized herein, are not utilized to limit the scope of the claimed invention or to imply that certain features are critical, essential, or even important to the structure or function of the claimed invention. Rather, these terms are merely intended to identify particular aspects of an embodiment of the present disclosure or to emphasize alternative or additional features that may or may not be utilized in a particular embodiment of the present disclosure.

For the purposes of describing and defining the present invention it is noted that the terms “substantially” and “approximately” are utilized herein to represent the inherent degree of uncertainty that may be attributed to any quantitative comparison, value, measurement, or other representation. The terms “substantially” and “approximately” are also utilized herein to represent the degree by which a quantitative representation may vary from a stated reference without resulting in a change in the basic function of the subject matter at issue.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Rather, the claims appended hereto should be taken as the sole representation of the breadth of the present disclosure and the corresponding scope of the various inventions described herein. Further, it will be apparent that modifications and variations are possible without departing from the scope of the invention defined in the appended claims. More specifically, although some aspects of the present disclosure are identified herein as preferred or particularly advantageous, it is contemplated that the present disclosure is not necessarily limited to these aspects.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

What is claimed is:

1-17. (canceled)

18. A composition comprising photoluminescent silicon nanoparticles having an average diameter ranging from about 2.2 to about 4.7 nm in a capture fluid, said silicon nanoparticles having a luminescent quantum efficiency, photoluminescent maximum emission wavelength that shifts to shorter wavelengths, or photoluminescent emission intensity that increases upon exposure to oxygen.

19-22. (canceled)

23. The composition according to claim 18, further comprising a silicon alloy.

24. The composition according to claim 18, wherein said capture fluid includes silicone fluids or any fluids having a vapor pressure lower than an operating pressure of the vacuum particle collection chamber, wherein said silicone fluids are selected from polydimethylsiloxane, phenylmethyl-dimethyl cyclosiloxane, tetramethyltetraphenyltrisiloxane, pentaphenyltrimethyltrisiloxane, and any combination thereof.

25. (canceled)

26. A method for collecting silicon nanoparticles comprising:
synthesizing said silicon nanoparticles in a reactor at a first pressure;
capturing said silicon nanoparticles in a capture fluid, the capture fluid being housed in a vacuum particle collection chamber, the vacuum particle collection chamber being located downstream of the reactor, the capture fluid being maintained at a second pressure, the second pressure being lower than the first pressure; and
collecting said silicon nanoparticles as an aerosol in the capture fluid at the second pressure.

27. The method according to claim 26, wherein said silicon nanoparticles are photoluminescent nanoparticles and wherein said photoluminescent nanoparticles are prepared by a process including:
in a vacuum plasma reactor having a reactant gas inlet and an outlet having an aperture therein, applying a preselected VHF radio frequency having a continuous frequency ranging from about 30 to about 500 MHz and a coupled power ranging from about 80 to about 1000 W to a reactant gas mixture to generate a plasma within the vacuum plasma reactor to form silicon nanoparticles having an average diameter ranging from about 2.2 to about 4.7 nm, said reactant gas mixture comprising from about 0.1 to about 50% by volume of a first precursor gas containing silicon, and at least one inert gas.

28. The method according to claim 27, wherein said reactant gas mixture is at a temperature ranging from about 20° C. to about 80° C. and a pressure ranging from about 1 to about 5 torr (about 133 Pa to about 665 Pa).

29. The method according to claim 27, wherein said capture fluid is in communication with said vacuum plasma reactor, said capture fluid being maintained at a temperature ranging from about −20° C. to about 150° C. and a pressure ranging from about 1 to about 5 millitorr (about 0.133 Pa to about 0.665 Pa).

30. The method according to claim 27, wherein said first precursor gas is selected from silanes, disilanes, halogen-substituted silanes, halogen-substituted disilanes, C1 to C4 alkyl silanes, C1 to C4 alkyl disilanes, and any combination thereof.

31. The method according to claim 27, wherein said reactant gas mixture further includes a second precursor gas comprising at least one element selected from carbon, germanium, boron, phosphorus, and nitrogen, and wherein the sum of the volumes of said first and second precursor gases includes from about 0.1 to about 50% by volume of said reactant gas mixture.

32. The method according to claim 27, wherein said reactant gas mixture further comprises hydrogen.

33. The method according to claim 27, wherein said capture fluid includes silicone fluids or any fluids having a vapor pressure lower than an operating pressure of the vacuum particle collection chamber.

34. The method according to claim 33, wherein said silicone fluid is selected from polydimethylsiloxane, phenylmethyl-dimethyl cyclosiloxane, tetramethyltetraphenyltrisiloxane, pentaphenyltrimethyltrisiloxane, and mixtures thereof.

35. The method according to claim 27, wherein said vacuum plasma reactor is in communication with said vacuum particle collection chamber through a pressure drop orifice.

36. The method according to claim 27, wherein said silicon nanoparticles include a silicon or a silicon alloy selected from silicon carbide, silicon germanium, silicon boron, silicon phosphorus, silicon nitride.

37. The method according to claim 27, further comprising doping said silicon nanoparticles by exposing said nanoparticles to an organosilicon compound in said capture fluid.

38. The method according to claim 27, further comprising passivating said silicon nanoparticles in said capture fluid by exposing said silicon nanoparticles to oxygen.

39. Silicon nanoparticles produced by the method of claim 27.

40. The method according to claim 27, wherein the plasma is generated for a time sufficient to form the silicon nanoparticles having the average diameter ranging from about 2.2 to about 4.7 nm.

41. A method for preparing photoluminescent silicon nanoparticles comprising:
forming, in a vacuum reactor, silicon nanoparticles having an average diameter ranging from about 2.2 to about 4.7 nm, said reactant gas mixture comprising from about 0.1 to about 50% by volume of a first precursor gas containing silicon, and at least one inert gas, wherein said silicon nanoparticles are produced as an aerosol in a sub-atmospheric environment; and
collecting said silicon nanoparticles in a capture fluid, wherein the capture fluid is housed in a vacuum particle collection chamber downstream of the vacuum chamber, the vacuum particle collection chamber being maintained at a lower pressure than the vacuum chamber.

42. The method of claim 41, wherein said capture fluid includes silicone fluids or any fluids having a vapor pressure lower than an operating pressure of the vacuum particle collection chamber, wherein said silicone fluids are selected from polydimethylsiloxane, phenylmethyl-dimethyl cyclosiloxane, tetramethyltetraphenyltrisiloxane, pentaphenyltrimethyltrisiloxane, and any combination thereof.
